(19) United States
(12) Patent Application Publication
(10) Pub. No.: US 2025/0148595 A1
(43) Pub. Date: May 8, 2025

(54) MEDICAL IMAGE ANALYSIS SYSTEM AND METHOD THEREOF

(71) Applicants: National Taiwan University, Taipei (TW); National Taiwan University Hospital, Taipei City (TW)

(72) Inventors: Wei-Chung Wang, Taipei (TW); Wei-Chih Liao, Taipei (TW); Po-Ting Chen, Taipei City (TW); Da-Wei Chang, Taipei (TW); Yen-Jia Chen, Taipei (TW); Yan-Chen Yeh, Taipei (TW); Po-Chuan Wang, Taipei (TW)

(21) Appl. No.: 18/932,383

(22) Filed: Oct. 30, 2024

Related U.S. Application Data
(60) Provisional application No. 63/547,258, filed on Nov. 3, 2023.

(51) Int. Cl. G06T 7/00; G06V 10/44

(52) U.S. Cl. CPC G06T 7/0012; G06V 10/44; G06T 2207/20081; G06T 2207/30096

(57) ABSTRACT

A medical image analysis system comprises: a database for storing a first medical image data indicating a target medical image; and a server for accessing the database. The server includes: a first analysis module for generating a first determination data according to the first medical image data; a second analysis module for generating a second determination data according to the first medical image data; and an ensemble module communicatively connected with the first and second analysis modules and generating a third determination data according to the first and second determination data. The first and second determination data each indicate whether the target medical image includes a cancerous tissue image or indicate a chance of the target medical image including a cancerous tissue image. The third determination data indicates whether the target medical image includes a cancerous tissue image.

### BACKGROUND OF THE INVENTION

### Field of the Invention

The present disclosure relates to a medical image analysis system and method thereof for determining whether a target medical image comprises a cancerous tissue image, and more particularly to a medical image analysis system and method thereof capable of including non-cancerous, abnormal tissue images in a determination process and/or a training process to accurately determine whether a target medical image comprises a cancerous tissue image.

### Description of the Prior Art

Conventional determination systems determining whether a medical image contains cancerous tissue (for example, with an Al system capable of determining whether a computed tomography (CT) medical image contains cancerous tissue) do not give considerations to non-cancerous, abnormal tissue (for example, inflammatory tissue) to the detriment of the accuracy in cancer diagnoses (for example, regarding non-cancerous, abnormal tissue as suggestive of cancer). Therefore, it is necessary to provide a medical image analysis system and method thereof capable of including non-cancerous, abnormal tissue images in a determination process and/or a training process. Preferably, the medical image analysis system and method thereof can further provide range data (or may be known as interval data) to allow users to use the range data and a determination result obtained through the medical image analysis system and method thereof in accurately evaluating the chance of a target medical image containing cancerous tissue.

### SUMMARY OF THE INVENTION

In view of the aforesaid drawback of the prior art, it is an objective of the disclosure to provide a medical image analysis system and method thereof capable of including non-cancerous, abnormal tissue images in a determination process and/or a training process to accurately determine whether a target medical image comprises a cancerous tissue image. Another objective of the disclosure is to provide a medical image analysis system and method thereof capable of providing range data to allow users to use the range data and a determination result obtained through the medical image analysis system and method thereof in accurately evaluating the chance of a target medical image containing cancerous tissue.

To achieve the above and other objectives, the disclosure provides a medical image analysis system comprising: a database for storing a first medical image data indicating a target medical image; and a server for accessing the database, the server comprising: a first analysis module for generating a first determination data according to the first medical image data, the first determination data indicating whether the target medical image comprises a cancerous tissue image or indicating a chance of the target medical image comprising a cancerous tissue image; a second analysis module for generating a second determination data according to the first medical image data, the second determination data indicating whether the target medical image comprises a cancerous tissue image or indicating a chance of the target medical image comprising a cancerous tissue image; and an ensemble module communicatively connected with the first analysis module and the second analysis module and generating a third determination data according to the first determination data and the second determination data, the third determination data indicating whether the target medical image comprises a cancerous tissue image or indicating a chance of the target medical image comprising a cancerous tissue image; wherein the server trains the first analysis module with a plurality of first image training data, a plurality of second image training data and a plurality of third image training data to allow the first analysis module to generate the first determination data according to the first medical image data, wherein the server trains the second analysis module with the plurality of first image training data, the plurality of second image training data and the plurality of third image training data to allow the second analysis module to generate the second determination data according to the first medical image data, wherein the plurality of first image training data each indicate a medical image containing normal tissue, the plurality of second image training data each indicate a medical image containing cancerous tissue, and the plurality of third image training data each indicate a medical image containing non-cancerous, abnormal tissue.

In a preferred embodiment of the disclosure, the first analysis module comprises a deep learning model, and the second analysis module comprises a radiomic module and a machine learning model, wherein the first analysis module generates the first determination data according to the first medical image data with the deep learning model, wherein the second analysis module generates the second determination data according to the first medical image data with the radiomic module and the machine learning model.

In a preferred embodiment of the disclosure, the server comprises a segmentation module communicatively connected with the first analysis module and the second analysis module, wherein the segmentation module generates a target image data according to the first medical image data, with the target image data correlating with the first medical image data and indicating a target organ image in the target medical image, wherein the first analysis module generates the first determination data according to the target image data correlating with the first medical image data, wherein the second analysis module generates the second determination data according to the target image data correlating with the first medical image data.

In a preferred embodiment of the disclosure, the radiomic module generates a feature data according to the target image data, and the machine learning model generates the second determination data according to the feature data.

In a preferred embodiment of the disclosure, the third determination data comprises a first risk data indicating a chance of the target medical image comprising a cancerous tissue image.

In a preferred embodiment of the disclosure, the database stores a plurality of second medical image data and a plurality of third medical image data, the plurality of second medical image data each indicate a specific non-cancerous tissue medical image, and the plurality of third medical image data each indicate a specific cancerous tissue medical image, wherein the server generates a fourth determination data according to each of the plurality of second medical image data, the plurality of fourth determination data each comprising a second risk data, wherein the server generates a fifth determination data according to each of the plurality of third medical image data, the plurality of fifth determination data each comprising a third risk data, wherein the server generates a range data according to the plurality of second risk data and the plurality of third risk data, the range data indicating a plurality of ranges (may be known as intervals).

In a preferred embodiment of the disclosure, the plurality of second risk data each indicate a first risk value, and the plurality of third risk data each indicate a second risk value, wherein the server sorts the plurality of second risk data by the plurality of first risk values and generates a plurality of non-cancerous ranges (may be known as non-cancerous intervals) according to the plurality of second risk data sorted, wherein the server sorts the plurality of third risk data by the plurality of second risk values and generates a plurality of cancerous ranges (may be known as cancerous intervals) according to the plurality of third risk data sorted, wherein the server generates the range data according to the plurality of non-cancerous ranges and the plurality of cancerous ranges.

In a preferred embodiment of the disclosure, the plurality of non-cancerous ranges comprise a first non-cancerous range, wherein a plurality of fourth risk data in the plurality of second risk data fall within the first non-cancerous range, wherein the server generates a first likelihood ratio data according to the plurality of fourth risk data, and the first likelihood ratio data indicates a first likelihood ratio value, wherein the server causes the range data to indicate the first non-cancerous range and the first likelihood ratio data, and causes the first non-cancerous range in the range data to correlate with the first likelihood ratio data in the range data.

In a preferred embodiment of the disclosure, the plurality of non-cancerous ranges comprise a first non-cancerous range and a second non-cancerous range preceding the first non-cancerous range, wherein a plurality of fourth risk data in the plurality of second risk data fall within the first non-cancerous range, and a plurality of fifth risk data in the plurality of second risk data fall within the second non-cancerous range, wherein the server generates a first likelihood ratio data according to the plurality of fourth risk data, and the first likelihood ratio data indicates a first likelihood ratio value, wherein the server generates a second likelihood ratio data according to the plurality of fifth risk data, and the second likelihood ratio data indicates a second likelihood ratio value, wherein the server combines the first non-cancerous range and the second non-cancerous range based on a first ratio between the first likelihood ratio value and the second likelihood ratio value is less than a first predetermined numerical value.

In a preferred embodiment of the disclosure, the plurality of cancerous ranges comprise a first cancerous range, wherein a plurality of sixth risk data in the plurality of third risk data fall within the first cancerous range, wherein the server generates a third likelihood ratio data according to the plurality of sixth risk data, and the third likelihood ratio data indicates a third likelihood ratio value, wherein the server causes the range data to indicate the first cancerous range and the third likelihood ratio data, and causes the first cancerous range in the range data to correlate with the third likelihood ratio data in the range data.

In a preferred embodiment of the disclosure, wherein the plurality of cancerous ranges comprise a first cancerous range and a second cancerous range preceding the first cancerous range, wherein a plurality of sixth risk data in the plurality of third risk data fall within the first cancerous range, and a plurality of seventh risk data in the plurality of third risk data fall within the second cancerous range, wherein the server generates a third likelihood ratio data according to the plurality of sixth risk data, and the third likelihood ratio data indicates a third likelihood ratio value, wherein the server generates a fourth likelihood ratio data according to the plurality of seventh risk data, and the fourth likelihood ratio data indicates a fourth likelihood ratio value, wherein the server combines the first cancerous range and the second cancerous range based on a second ratio between the third likelihood ratio value and the fourth likelihood ratio value is less than a second predetermined numerical value.

To achieve the above and other objectives, the disclosure further provides a medical image analysis method, applicable to a medical image analysis system comprising a database and a server, the server accessing the database and comprising a first analysis module, a second analysis module and an ensemble module, the database storing a first medical image data indicating a target medical image, the ensemble module communicatively connected with the first analysis module and the second analysis module, wherein the medical image analysis method comprises the steps of: training, by the server, the first analysis module with a plurality of first image training data, a plurality of second image training data and a plurality of third image training data to allow the first analysis module to generate a first determination data according to the first medical image data; training, by the server, the second analysis module with the plurality of first image training data, the plurality of second image training data and the plurality of third image training data to allow the second analysis module to generate a second determination data according to the first medical image data; generating, by the first analysis module, the first determination data according to the first medical image data, the first determination data indicating whether the target medical image comprises a cancerous tissue image or indicating a chance of the target medical image comprising a cancerous tissue image; generating, by the second analysis module, the second determination data according to the first medical image data, the second determination data indicating whether the target medical image comprises a cancerous tissue image or indicating a chance of the target medical image comprising a cancerous tissue image; and generating, by the ensemble module, a third determination data according to the first determination data and the second determination data, the third determination data indicating whether the target medical image comprises a cancerous tissue image or indicating a chance of the target medical image comprising a cancerous tissue image, wherein the plurality of first image training data each indicate a medical image containing normal tissue, the plurality of second image training data each indicate a medical image containing cancerous tissue, and the plurality of third image training data each indicate a medical image containing non-cancerous, abnormal tissue.

In a preferred embodiment of the disclosure, the first analysis module comprises a deep learning model, and the second analysis module comprises a radiomic module and a machine learning model, wherein the medical image analysis method further comprises the steps of: generating, by the first analysis module, the first determination data according to the first medical image data with the deep learning model; and generating, by the second analysis module, the second determination data according to the first medical image data with the radiomic module and the machine learning model.

In a preferred embodiment of the disclosure, the server comprises a segmentation module communicatively connected with the first analysis module and the second analysis module, wherein the medical image analysis method further comprises the steps of: generating, by the segmentation module, a target image data according to the first medical image data, the target image data correlating with the first medical image data and indicating a target organ image in the target medical image; generating, by the first analysis module, the first determination data according to the target image data correlating with the first medical image data; and generating, by the second analysis module, the second determination data according to the target image data correlating with the first medical image data.

In a preferred embodiment of the disclosure, the medical image analysis method further comprises the steps of: generating, by the radiomic module, a feature data according to the target image data; and generating, by the machine learning model, the second determination data according to the feature data.

In a preferred embodiment of the disclosure, the third determination data comprises a first risk data, and the first risk data indicates a chance of the target medical image comprising a cancerous tissue image.

In a preferred embodiment of the disclosure, the database stores a plurality of second medical image data and a plurality of third medical image data, the plurality of second medical image data each indicate a specific non-cancerous tissue medical image, and the plurality of third medical image data each indicate a specific cancerous tissue medical image, wherein the medical image analysis method further comprises the steps of: generating, by the server, a fourth determination data according to each of the plurality of second medical image data, the plurality of fourth determination data each comprising a second risk data; generating, by the server, a fifth determination data according to each of the plurality of third medical image data, the plurality of fifth determination data each comprising a third risk data; and generating, by the server, a range data according to the plurality of second risk data and the plurality of third risk data, the range data indicating a plurality of ranges.

In a preferred embodiment of the disclosure, the plurality of second risk data each indicate a first risk value, and the plurality of third risk data each indicate a second risk value, wherein the medical image analysis method further comprises the steps of: sorting, by the server, the plurality of second risk data by the plurality of first risk values; generating, by the server, a plurality of non-cancerous ranges according to the plurality of second risk data sorted; sorting, by the server, the plurality of third risk data by the plurality of second risk values; generating, by the server, a plurality of cancerous ranges according to the plurality of third risk data sorted; and generating, by the server, the range data according to the plurality of non-cancerous ranges and the plurality of cancerous ranges.

In a preferred embodiment of the disclosure, the plurality of non-cancerous ranges comprise a first non-cancerous range, and a plurality of fourth risk data in the plurality of second risk data fall within the first non-cancerous range, wherein the medical image analysis method further comprises the steps of: generating, by the server, a first likelihood ratio data according to the plurality of fourth risk data, the first likelihood ratio data indicating a first likelihood ratio value; causing, by the server, the range data to indicate the first non-cancerous range and the first likelihood ratio data; and causing, by the server, the first non-cancerous range in the range data to correlate with the first likelihood ratio data in the range data.

In a preferred embodiment of the disclosure, the plurality of non-cancerous ranges comprise a first non-cancerous range and a second non-cancerous range preceding the first non-cancerous range, a plurality of fourth risk data in the plurality of second risk data fall within the first non-cancerous range, and a plurality of fifth risk data in the plurality of second risk data fall within the second non-cancerous range, wherein the medical image analysis method further comprises the steps of: generating, by the server, a first likelihood ratio data according to the plurality of fourth risk data, the first likelihood ratio data indicating a first likelihood ratio value; generating, by the server, a second likelihood ratio data according to the plurality of fifth risk data, the second likelihood ratio data indicating a second likelihood ratio value; and combining, by the server, the first non-cancerous range and the second non-cancerous range based on a first ratio between the first likelihood ratio value and the second likelihood ratio value is less than a first predetermined numerical value.

In a preferred embodiment of the disclosure, the plurality of cancerous ranges comprise a first cancerous range, and a plurality of sixth risk data in the plurality of third risk data fall within the first cancerous range, wherein the medical image analysis method further comprises the steps of: generating, by the server, a third likelihood ratio data according to the plurality of sixth risk data, the third likelihood ratio data indicating a third likelihood ratio value; causing, by the server, the range data to indicate the first cancerous range and the third likelihood ratio data; and causing, by the server, the first cancerous range in the range data to correlate with the third likelihood ratio data in the range data.

In a preferred embodiment of the disclosure, the plurality of cancerous ranges comprise a first cancerous range and a second cancerous range preceding the first cancerous range, a plurality of sixth risk data in the plurality of third risk data fall within the first cancerous range, and a plurality of seventh risk data in the plurality of third risk data fall within the second cancerous range, wherein the medical image analysis method further comprises the steps of: generating, by the server, a third likelihood ratio data according to the plurality of sixth risk data, the third likelihood ratio data indicating a third likelihood ratio value; generating, by the server, a fourth likelihood ratio data according to the plurality of seventh risk data, the fourth likelihood ratio data indicating a fourth likelihood ratio value; and combining, by the server, the first cancerous range and the second cancerous range based on a second ratio between the third likelihood ratio value and the fourth likelihood ratio value is less than a second predetermined numerical value.

Persons skilled in the art can gain insight into the aforesaid aspects and other aspects of the disclosure by studying the detailed description of the non-restrictive, specific embodiments, and the accompanying drawings of the disclosure.

### BRIEF DESCRIPTION OF THE DRAWINGS

FIG. 1 is a block diagram of a medical image analysis system according to a specific embodiment of the disclosure.

FIG. 2 is a schematic view of a process flow of a medical image analysis method according to a specific embodiment of the disclosure.

### DETAILED DESCRIPTION OF THE EMBODIMENTS

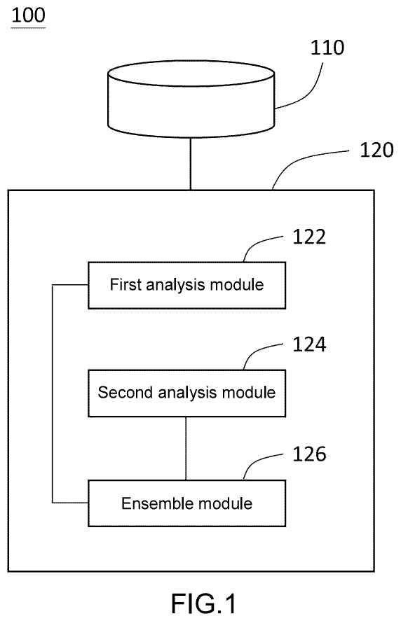

Referring to FIG. 1, there is shown a block diagram of a medical image analysis system according to a specific embodiment of the disclosure. In the embodiment illustrated by FIG. 1, a medical image analysis system 100 comprises a database 110 and a server 120. The server 120 accesses (for example, communicatively connects with) the database 110. The server 120 comprises a first analysis module 122, a second analysis module 124 and an ensemble module 126. The ensemble module 126 is communicatively connected with the first analysis module 122 and the second analysis module 124. The server 120 is, for example, a computer device, computer, processing device or mobile device, but the disclosure is not limited thereto.

In a specific embodiment, the server 120 comprises a transmission module and accesses the database 110 through the transmission module. The server 120 sends data (for example, image data, graphical data, and text data, but the disclosure is not limited thereto) to the database 110 through the transmission module or receives data (for example, image data, graphical data, and text data, but the disclosure is not limited thereto) from the database 110 through the transmission module. Preferably, the database 110 has one or more processors and performs its functions through hardware-software synergy. The server 120 has one or more processors and performs its functions and functions of its modules through hardware-software synergy.

In the embodiment illustrated by FIG. 1, the database 110 stores a first medical image data, and the first medical image data indicates a target medical image. The first analysis module 122 of the server 120 generates a first determination data according to the first medical image data. The first determination data indicates whether the target medical image comprises a cancerous tissue image or indicates a chance (known as a first chance) of the target medical image comprising a cancerous tissue image. The second analysis module 124 of the server 120 generates a second determination data according to the first medical image data. The second determination data indicates whether the target medical image comprises a cancerous tissue image or indicates a chance (known as a second chance) of the target medical image comprising a cancerous tissue image. The ensemble module 126 of the server 120 generates a third determination data according to the first determination data and the second determination data. The third determination data indicates whether the target medical image comprises a cancerous tissue image or indicates a chance (known as a third chance) of the target medical image comprising a cancerous tissue image. It is noteworthy that the third determination data can also be a risk value or probability to indicate whether the target medical image comprises a cancerous tissue image.

In a specific embodiment, the target medical image is a computed tomography (CT) image. It is noteworthy that the target medical image is a CT image, a magnetic resonance imaging (MRI) image, an ultrasound image, or any other medical image as needed. The target medical image is a two-dimensional medical image, a three-dimensional medical image, or a three-dimensional medical image comprising the two-dimensional medical image as needed. In a specific embodiment, the medical image analysis system 100 is for use in diagnosing pancreatic cancer. It is noteworthy that the medical image analysis system 100 is not only for use in diagnosing pancreatic cancer but also for use in diagnosing any other types of cancer as needed.

In different specific embodiments, the first analysis module generates the first determination data with the analysis method of one of the American patent applications as follows: application Ser. No. 16/868,742 (MEDICAL IMAGE ANALYZING SYSTEM AND METHOD THEREOF), application Ser. No. 17/137,647 (MEDICAL IMAGE ANALYZING SYSTEM AND METHOD THEREOF), application Ser. No. 17/507,949 (MEDICAL IMAGE ANALYZING SYSTEM AND METHOD THEREOF), and application Ser. No. 17/507,948 (MEDICAL IMAGE ANALYZING SYSTEM AND METHOD THEREOF); however, the disclosure is not limited thereto. The entire contents of application Ser. No. 16/868,742 (MEDICAL IMAGE ANALYZING SYSTEM AND METHOD THEREOF), application Ser. No. 17/137,647 (MEDICAL IMAGE ANALYZING SYSTEM AND METHOD THEREOF), application Ser. No. 17/507,949 (MEDICAL IMAGE ANALYZING SYSTEM AND METHOD THEREOF), application Ser. No. 17/507,948 (MEDICAL IMAGE ANALYZING SYSTEM AND METHOD THEREOF) are hereby incorporated by reference.

In different specific embodiments, the second analysis module generates the second determination data with the analysis method of one of the American patent applications as follows: application Ser. No. 16/868,742 (MEDICAL IMAGE ANALYZING SYSTEM AND METHOD THEREOF), application Ser. No. 17/137,647 (MEDICAL IMAGE ANALYZING SYSTEM AND METHOD THEREOF), application Ser. No. 17/507,949 (MEDICAL IMAGE ANALYZING SYSTEM AND METHOD THEREOF), and application Ser. No. 17/507,948 (MEDICAL IMAGE ANALYZING SYSTEM AND METHOD THEREOF); however, the disclosure is not limited thereto. Preferably, the way the first analysis module generates the first determination data is different from the way the second analysis module generates the second determination data.

In a specific embodiment, the ensemble module 126 comprises a deep learning model and generates the third determination data according to the first determination data and the second determination data with the deep learning model. In a specific embodiment, the ensemble module comprises a machine learning model and generates the third determination data according to the first determination data and the second determination data with the machine learning model. In a specific embodiment, the ensemble module comprises an artificial neural network model and generates the third determination data according to the first determination data and the second determination data with the artificial neural network model. In a specific embodiment, the ensemble module comprises a logistic regression model and generates the third determination data according to the first determination data and the second determination data with the logistic regression model.

In the embodiment illustrated by FIG. 1, the database 110 stores a plurality of first image training data, a plurality of second image training data and a plurality of third image training data. The server 120 trains the first analysis module 122 with a plurality of first image training data, a plurality of second image training data and a plurality of third image training data to allow the first analysis module 122 to generate the first determination data according to the first medical image data. The server 120 trains the second analysis module 124 with a plurality of first image training data, a plurality of second image training data and a plurality of third image training data to allow the second analysis module 124 to generate the second determination data according to the first medical image data. The plurality of first image training data each indicate a medical image containing normal tissue. The plurality of second image training data each indicate a medical image containing cancerous tissue. The plurality of third image training data each indicate a medical image containing non-cancerous, abnormal tissue. For instance, a medical image that contains normal pancreatic tissue is a medical image that contains normal tissue. A medical image that contains pancreatic cancer tissue is a medical image that contains cancerous tissue. A medical image containing acute pancreatitis tissue images, a medical image containing chronic pancreatitis tissue images, and a medical image containing pancreatic cystic lesion tissue images are medical images that contain non-cancerous, abnormal tissue.

Therefore, the first analysis module 122, and/or the second analysis module 124, and/or the ensemble module 126 not only distinguish cancerous tissue medical images from normal tissue images but also distinguish cancerous tissue images from non-cancerous, abnormal tissue images. Therefore, it is impossible (or unlikely) for the first analysis module 122, and/or the second analysis module 124, and/or the ensemble module 126 to mistake non-cancerous, abnormal tissue images for cancerous tissue images. Preferably, each medical image, which contains normal tissue image and is indicated by one of the plurality of first image training data, contains only normal tissue image, but does not contain cancerous tissue image and non-cancerous, abnormal tissue image. Preferably, each medical image, which contains non-cancerous, abnormal tissue image and is indicated by one of the plurality of third image training data, does not contain cancerous tissue image.

In a specific embodiment, the first analysis module 122 comprises a deep learning model, and the second analysis module 124 comprises a radiomic module and a machine learning model. The first analysis module 122 generates the first determination data according to the first medical image data with the deep learning model. The second analysis module 124 generates the second determination data according to the first medical image data with the radiomic module and the machine learning model. Therefore, the medical image analysis system 100 not only analyzes the first medical image data by different means of analysis (deep learning analysis, radiomic analysis, and machine learning analysis) but also ensembles the aforesaid means of analysis with the ensemble module 126 to generate the third determination data so as to obtain an accurate determination result.

Preferably, if the first analysis module 122 and the ensemble module 126 each comprise a deep learning model, it will be feasible to refer to the deep learning model of the first analysis module 122 as a first deep learning model and the deep learning model of the ensemble module 126 as a second deep learning model. Preferably, if the second analysis module 124 and the ensemble module 126 each comprise a machine learning model, it will be feasible to refer to the machine learning model of the second analysis module 124 as a first machine learning model and the machine learning model of the ensemble module 126 as a second machine learning model.

In a specific embodiment, the server 120 comprises a segmentation module. The segmentation module is communicatively connected with the first analysis module 122 and the second analysis module 124. The segmentation module generates a target image data according to the first medical image data. The target image data correlates with the first medical image data and indicates a target organ image in the target medical image. The first analysis module 122 generates the first determination data according to the target image data which correlates with the first medical image data. The second analysis module 124 generates the second determination data according to the target image data which correlates with the first medical image data.

In a specific embodiment, to train the second analysis module 124 with training data (exemplified by the plurality of first image training data, the plurality of second image training data and the plurality of third image training data, but the disclosure is not limited thereto), medical professionals select normal tissue images, and/or non-cancerous, abnormal tissue images, and/or cancerous tissue images from images of training data and generate normal tissue image data, and/or non-cancerous, abnormal tissue image data, and/or cancerous tissue image data respectively. Thus, the server causes the training data to comprise normal tissue image data, and/or non-cancerous, abnormal tissue image data, and/or cancerous tissue image data respectively, allowing the second analysis module 124 and/or the first analysis module 122 to be trained with the training data.

In a specific embodiment, upon completion of the training, the segmentation module independently generates the target image data according to the medical image data, dispensing the medical professionals with the need to select normal tissue images, and/or non-cancerous, abnormal tissue images, and/or cancerous tissue images. The target image data independently generated by the segmentation module comprises a normal tissue image data, and/or a non-cancerous, abnormal tissue image data, and/or a cancerous tissue image data corresponding to the target image data.

In a specific embodiment, the segmentation module is included in the first analysis module 122 and/or the second analysis module 124. In a specific embodiment, the segmentation module identifies the outline of a target organ image and cuts out the target organ image from a target medical image to generate the target image data. For instance, when the medical professionals use the medical image analysis system 100 to determine whether a target patient has pancreatic cancer, the segmentation module identifies the outline of a pancreatic image in the first medical image data and cuts out the pancreatic image from the first medical image data to generate the target image data. In a specific embodiment, the segmentation module cuts out a normal tissue image from the target organ image to generate a normal tissue image data. The segmentation module cuts out a cancerous tissue image and/or a non-cancerous, abnormal tissue image from the target organ image to generate a cancerous tissue image data and/or a non-cancerous, abnormal tissue image data. Preferably, the target organ image comprises a normal tissue image, and/or a cancerous tissue image, and/or a non-cancerous, abnormal tissue image, and the target image data comprises a normal tissue image data, and/or a cancerous tissue image data, and/or a non-cancerous, abnormal tissue image data.

In a specific embodiment, the radiomic module of the second analysis module 124 generates a feature data according to the target image data. The machine learning model of the second analysis module 124 generates the second determination data according to the feature data. Preferably, the feature data indicates one or more features of the target organ image. For instance, the feature data indicates the average intensity, organ shape, specific tissue shape (for example, tissue shape suggestive of cancer), and intensity difference between adjacent pixels of the target organ image, but the disclosure is not limited thereto. In a specific embodiment, the third determination data comprises a first risk data, and the first risk data indicates a chance of the target medical image comprising a cancerous tissue image. In different specific embodiments, a risk data indicates a risk value or a risk probability, but the disclosure is not limited thereto.

In a specific embodiment, the database 110 stores a plurality of second medical image data and a plurality of third medical image data. The plurality of second medical image data each indicate a specific non-cancerous tissue medical image. The plurality of third medical image data each indicate a specific cancerous tissue medical image. The server 120 generates a fourth determination data according to each of the plurality of second medical image data. The plurality of fourth determination data each comprise a second risk data. The server 120 generates a fifth determination data according to each of the plurality of third medical image data. The plurality of fifth determination data each comprise a third risk data. The server 120 generates a range data according to the plurality of second risk data and the plurality of third risk data, and the range data indicates a plurality of ranges. In a specific embodiment, when the medical image analysis system 100 generates the third determination data according to the first medical image data, the medical professionals and/or patients become aware of which of the ranges the third determination data falls within (for example, which of the ranges the first risk data in the third determination data falls within) according to the range data. Therefore, the medical professionals and/or patients can accurately determine a chance that the target medical image indicated by a medical image data is suggestive of cancer according to the range that the third determination data correlates with.

Preferably, the specific non-cancerous tissue medical image is a medical image that does not contain cancerous tissue (but may contain non-cancerous, abnormal tissue or lesion tissue, for example, pancreatitis tissue, but the disclosure is not limited thereto.) Preferably, the specific cancerous tissue medical image is a medical image that contains cancerous tissue. It is noteworthy that input data for use in the course of the generation of range data by the medical image analysis system are a plurality of medical images known to contain no cancerous tissue and a plurality of medical images known to contain cancerous tissue in order for reliable range data to be generated.

Preferably, each second medical image data generates the fourth determination data. The server 120 can generate the fourth determination data according to a second medical image data in the same way as generating the third determination data according to a medical image data. Preferably, each third medical image data generates the fifth determination data. The server 120 can generate the fifth determination data according to a third medical image data in the same way as generating the third determination data according to a medical image data.

In a specific embodiment, the plurality of second risk data each indicate a first risk value, and the plurality of third risk data each indicate a second risk value. The server 120 sorts the plurality of second risk data by the plurality of first risk values. The server 120 generates a plurality of non-cancerous ranges according to the plurality of second risk data sorted. The server 120 sorts the plurality of third risk data by the plurality of second risk values. The server 120 generates a plurality of cancerous ranges according to the plurality of third risk data sorted. The server 120 further generates the range data according to the plurality of non-cancerous ranges and the plurality of cancerous ranges. For instance, the server 120 causes the range data to indicate the plurality of non-cancerous ranges and the plurality of cancerous ranges. Alternatively, the server 120 causes the range data to indicate the plurality of non-cancerous ranges and the plurality of cancerous ranges.

In a specific embodiment, the server 120 sorts a plurality of second risk data and then allocates the plurality of second risk data to several non-cancerous ranges (in a specific number as needed). The non-cancerous ranges are equal or substantially equal in terms of the number of the second risk data they contain. For instance, given 1000 second risk data, the server 120 sorts the second risk data by their first risk values. Then, the second risk data are allocated to M non-cancerous ranges, and each non-cancerous range has 1000/M second risk data.

In a specific embodiment, the server 120 sorts a plurality of third risk data and then allocates the plurality of third risk data to several cancerous ranges (the number of the cancerous ranges can be determine or adjust according to the needs). The cancerous ranges are equal or substantially equal in terms of the number of the third risk data they contain. For instance, given 1000 third risk data, the server 120 sorts the third risk data by their second risk values. Then, the third risk data are allocated to N non-cancerous ranges, and each non-cancerous range has 1000/N third risk data.

In a specific embodiment, the plurality of non-cancerous ranges comprise a first non-cancerous range, and a plurality of fourth risk data in the plurality of second risk data fall within the first non-cancerous range. The server 120 generates a first likelihood ratio data according to the plurality of fourth risk data, and the first likelihood ratio data indicates a first likelihood ratio value. The server 120 causes the range data to indicate the first non-cancerous range and the first likelihood ratio data. The server 120 causes the first non-cancerous range indicated by the range data to correlate with the first likelihood ratio data indicated by the range data. Preferably, the server 120 generates a likelihood ratio data for each non-cancerous range. Therefore, users become aware of the likelihood ratio values for the non-cancerous ranges respectively.

In a specific embodiment, the plurality of non-cancerous ranges comprise a first non-cancerous range and a second non-cancerous range that precedes the first non-cancerous range. A plurality of fourth risk data in the plurality of second risk data fall within the first non-cancerous range. A plurality of fifth risk data in the plurality of second risk data fall within the second non-cancerous range. The server 120 generates a first likelihood ratio data according to the plurality of fourth risk data. The first likelihood ratio data indicates a first likelihood ratio value. The server 120 generates a second likelihood ratio data according to the plurality of fifth risk data. The second likelihood ratio data indicates a second likelihood ratio value. The server 120 combines the first non-cancerous range and the second non-cancerous range when a ratio between the first likelihood ratio value and the second likelihood ratio value is less than a first predetermined numerical value, with the ratio being also known as a first ratio, which is the quotient obtained by dividing the first likelihood ratio value by the second likelihood ratio value or vice versa. In a specific embodiment, the first likelihood ratio value is less than the second likelihood ratio value, and the first ratio is the quotient obtained by dividing the second likelihood ratio value by the first likelihood ratio value (i.e., the first likelihood ratio value is the denominator, and the second likelihood ratio value is the numerator.)

For instance, the server 120 calculates the first likelihood ratio value with all the fourth risk data in the first non-cancerous range, and calculates the second likelihood ratio value with all the fifth risk data in the second non-cancerous range. If the ratio between the first likelihood ratio value and the second likelihood ratio value is less than the first predetermined numerical value X1 (also known as a first ratio, which is the quotient of the first likelihood ratio value and the second likelihood ratio value,) it will suggest insignificant likelihood ratio difference between the first non-cancerous range and the second non-cancerous range; thus, the server 120 will combine the first non-cancerous range and the second non-cancerous range.

In a specific embodiment, the plurality of cancerous ranges comprise a first cancerous range, and a plurality of sixth risk data in the plurality of third risk data fall within the first cancerous range. The server 120 generates a third likelihood ratio data according to the plurality of sixth risk data, and the third likelihood ratio data indicates a third likelihood ratio value. The server 120 causes the range data to indicate the first cancerous range and the third likelihood ratio data. Furthermore, the server 120 causes the first cancerous range in the range data to correlate with the third likelihood ratio data in the range data. Preferably, the server 120 generates the likelihood ratio data corresponding to each cancerous range. Therefore, the users become aware of the likelihood ratio value corresponding to each cancerous range.

In a specific embodiment, the plurality of cancerous ranges comprise a first cancerous range and a second cancerous range preceding the first cancerous range. A plurality of sixth risk data in the plurality of third risk data fall within the first cancerous range. A plurality of seventh risk data in the plurality of third risk data fall within the second cancerous range. The server 120 generates a third likelihood ratio data according to the plurality of sixth risk data. The third likelihood ratio data indicates a third likelihood ratio value. The server 120 generates a fourth likelihood ratio data according to the plurality of seventh risk data. The fourth likelihood ratio data indicates a fourth likelihood ratio value. The server 120 combines the first cancerous range and the second cancerous range when the ratio between the third likelihood ratio value and the fourth likelihood ratio value is less than a second predetermined numerical value, with the ratio being also known as a second ratio, which is the quotient obtained by dividing the third likelihood ratio value by the fourth likelihood ratio value or vice versa. In a specific embodiment, the third likelihood ratio value is less than the fourth likelihood ratio value, and the second ratio is the quotient obtained by dividing the fourth likelihood ratio value by the third likelihood ratio value (i.e., the fourth likelihood ratio value is the numerator, and the third likelihood ratio value is the denominator.)

For instance, the server 120 calculates the third likelihood ratio value with all the sixth risk data in the first cancerous range. The server 120 calculates the fourth likelihood ratio value with all the seventh risk data in the second cancerous range. If the ratio between the third likelihood ratio value and the fourth likelihood ratio value is less than the second predetermined numerical value X2 (also known as a second ratio, which is the quotient of the third likelihood ratio value and the fourth likelihood ratio value,) it will suggest insignificant likelihood ratio difference between the first cancerous range and the second cancerous range, allowing the server 120 to combine the first cancerous range and the second cancerous range.

Therefore, the server 120 can determine whether the likelihood ratio difference between two adjacent ranges is sufficiently significant. If the server 120 determines that the likelihood ratio difference between the two adjacent ranges is not sufficiently significant, the server 120 will combine the two adjacent ranges. Therefore, the range data generated by the medical image analysis system 100 comprises a plurality of ranges with sufficiently significant likelihood ratio difference therebetween.

In a specific embodiment, the first non-cancerous range and the second non-cancerous range can be combined to form a non-cancerous combinational range. Upon the combination of the first non-cancerous range and the second non-cancerous range to form a non-cancerous combinational range, the server 120 generates (for example, calculates) a fifth likelihood ratio data according to the plurality of fourth risk data and the plurality of fifth risk data, and the fifth likelihood ratio data indicates a fifth likelihood ratio value. The server 120 causes the range data to indicate the non-cancerous combinational range and the fifth likelihood ratio data. Furthermore, the server 120 causes the non-cancerous combinational range in the range data to correlate with the fifth likelihood ratio data in the range data. Preferably, the server 120 generates a likelihood ratio data corresponding to each of the non-cancerous ranges resulting from range combination. Therefore, the users become aware of the likelihood ratio value corresponding to each non-cancerous combinational range.

In a specific embodiment, the first cancerous range and the second cancerous range can be combined to form a cancerous combinational range. Upon the combination of the first cancerous range and the second cancerous range to form a cancerous combinational range, the server 120 generates (for example, calculates) a sixth likelihood ratio data according to the plurality of sixth risk data and the plurality of seventh risk data, and the sixth likelihood ratio data indicates a sixth likelihood ratio value. The server 120 causes the range data to indicate the cancerous combinational range and the sixth likelihood ratio data. Furthermore, the server 120 causes the cancerous combinational range in the range data to correlate with the sixth likelihood ratio data in the range data. Preferably, the server 120 generates the likelihood ratio data corresponding to each of the cancerous ranges resulting from range combination. Therefore, the users become aware of the likelihood ratio value corresponding to each cancerous combinational range.

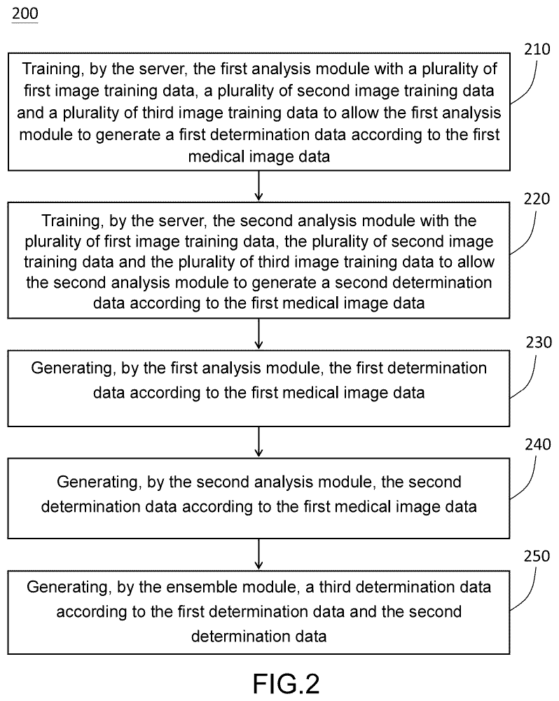

Referring to FIG. 2, there is shown a schematic view of a process flow of a medical image analysis method according to a specific embodiment of the disclosure. In the embodiment illustrated by FIG. 2, a medical image analysis method 200 is applicable to a medical image analysis system. The medical image analysis system comprises a database and a server. The server comprises a first analysis module, a second analysis module and an ensemble module. The server accesses the database. The ensemble module is communicatively connected with the first analysis module and the second analysis module. The database stores a first medical image data. The first medical image data indicates a target medical image. The medical image analysis method 200 starts with step 210, in which the server trains the first analysis module with a plurality of first image training data, a plurality of second image training data and a plurality of third image training data to allow the first analysis module to generate the first determination data according to the first medical image data. Then, in step 220 the server trains the second analysis module with the plurality of first image training data, the plurality of second image training data and the plurality of third image training data to allow the second analysis module to generate the second determination data according to the first medical image data. The plurality of first image training data each indicate a medical image containing normal tissue. The plurality of second image training data each indicate a medical image containing cancerous tissue. The plurality of third image training data each indicate a medical image containing non-cancerous, abnormal tissue.

In step 230, the first analysis module generates the first determination data according to the first medical image data. The first determination data indicates whether the target medical image comprises a cancerous tissue image or indicates a chance of the target medical image comprising a cancerous tissue image. In step 240, the second analysis module generates the second determination data according to the first medical image data. The second determination data indicates whether the target medical image comprises a cancerous tissue image or indicates a chance of the target medical image comprising a cancerous tissue image. In step 250, the ensemble module generates a third determination data according to the first determination data and the second determination data. The third determination data indicates whether the target medical image comprises a cancerous tissue image or indicates a chance of the target medical image comprising a cancerous tissue image.

In a specific embodiment, the first analysis module comprises a deep learning model, and the second analysis module comprises a radiomic module and a machine learning model. The medical image analysis method 200 further comprises the steps of: generating, by the first analysis module, the first determination data according to the first medical image data with the deep learning model; and generating, by the second analysis module, the second determination data according to the first medical image data, with the radiomic module and the machine learning model.

In a specific embodiment, the server comprises a segmentation module communicatively connected with the first analysis module and the second analysis module, allowing the medical image analysis method 200 to further comprise the steps of: generating, by the segmentation module, a target image data according to the first medical image data, with the target image data correlating with the first medical image data and indicating a target organ image in the target medical image; generating, by the first analysis module, the first determination data according to the target image data correlating with the first medical image data; and generating, by the second analysis module, the second determination data according to the target image data correlating with the first medical image data.

In a specific embodiment, the medical image analysis method 200 further comprises the steps of: generating a feature data according to the target image data with the radiomic module; and generating the second determination data according to the feature data with the machine learning model.

In a specific embodiment, the database stores a plurality of second medical image data and a plurality of third medical image data. The plurality of second medical image data each indicate a specific non-cancerous tissue medical image. The plurality of third medical image data each indicate a specific cancerous tissue medical image. The medical image analysis method 200 further comprises the steps of: generating, by the server, a fourth determination data according to each of the plurality of second medical image data, with the plurality of fourth determination data each comprising a second risk data; generating, by the server, a fifth determination data according to each of the plurality of third medical image data, with the plurality of fifth determination data each comprising a third risk data; and generating, by the server, a range data according to the plurality of second risk data and the plurality of third risk data, with the range data indicating a plurality of ranges.

In a specific embodiment, the plurality of second risk data each indicate a first risk value, and the plurality of third risk data each indicate a second risk value. The medical image analysis method 200 further comprises the steps of: sorting, by the server, the plurality of second risk data by the plurality of first risk values; generating, by the server, a plurality of non-cancerous ranges according to the plurality of second risk data sorted; sorting, by the server, the plurality of third risk data by the plurality of second risk values; generating, by the server, a plurality of cancerous ranges according to the plurality of third risk data sorted; and generating, by the server, the range data according to the plurality of non-cancerous ranges and the plurality of cancerous ranges.

In a specific embodiment, the plurality of non-cancerous ranges comprise a first non-cancerous range, and a plurality of fourth risk data in the plurality of second risk data fall within the first non-cancerous range, allowing the medical image analysis method to further comprise the steps of: generating, by the server, a first likelihood ratio data according to the plurality of fourth risk data, with the first likelihood ratio data indicating a first likelihood ratio value; causing, by the server, the range data to indicate the first non-cancerous range and the first likelihood ratio data; and causing, by the server, the first non-cancerous range in the range data to correlate with the first likelihood ratio data in the range data.

In a specific embodiment, the plurality of non-cancerous ranges comprise a first non-cancerous range and a second non-cancerous range preceding the first non-cancerous range. A plurality of fourth risk data in the plurality of second risk data fall within the first non-cancerous range. A plurality of fifth risk data in the plurality of second risk data fall within the second non-cancerous range. The medical image analysis method 200 further comprises the steps of: generating, by the server, a first likelihood ratio data according to the plurality of fourth risk data, with the first likelihood ratio data indicating a first likelihood ratio value; generating, by the server, a second likelihood ratio data according to the plurality of fifth risk data, with the second likelihood ratio data indicating a second likelihood ratio value; and combining, by the server, the first non-cancerous range and the second non-cancerous range when a ratio (also known as a first ratio) between the first likelihood ratio value and the second likelihood ratio value is less than a first predetermined numerical value. In a specific embodiment, the first likelihood ratio value is less than the second likelihood ratio value, and the first ratio is obtained by dividing the second likelihood ratio value by the first likelihood ratio value (i.e., the first likelihood ratio value is the denominator, and the second likelihood ratio value is the numerator.)

In a specific embodiment, the plurality of cancerous ranges comprise a first cancerous range, and a plurality of sixth risk data in the plurality of third risk data fall within the first cancerous range, allowing the medical image analysis method to further comprise the steps of: generating, by the server, a third likelihood ratio data according to the plurality of sixth risk data, with the third likelihood ratio data indicating a third likelihood ratio value; causing, by the server, the range data to indicate the first cancerous range and the third likelihood ratio data; and causing, by the server, the first cancerous range in the range data to correlate with the third likelihood ratio data in the range data.

In a specific embodiment, the plurality of cancerous ranges comprise a first cancerous range and a second cancerous range preceding the first cancerous range. A plurality of sixth risk data in the plurality of third risk data fall within the first cancerous range, and a plurality of seventh risk data in the plurality of third risk data fall within the second cancerous range, allowing the medical image analysis method 200 to further comprise the steps of: generating, by the server, a third likelihood ratio data according to the plurality of sixth risk data, with the third likelihood ratio data indicating a third likelihood ratio value; generating, by the server, a fourth likelihood ratio data according to the plurality of seventh risk data, with the fourth likelihood ratio data indicating a fourth likelihood ratio value; and combining, by the server, the first cancerous range and the second cancerous range when the ratio (also known as a second ratio) between the third likelihood ratio value and the fourth likelihood ratio value is less than a second predetermined numerical value. In a specific embodiment, the third likelihood ratio value is less than the fourth likelihood ratio value, and the second ratio is obtained by dividing the fourth likelihood ratio value by the third likelihood ratio value (i.e., the fourth likelihood ratio value is the numerator, and third likelihood ratio value is the denominator.)

Therefore, the medical image analysis system and method thereof of the disclosure are illustrated by specific embodiments, depicted by the accompanying drawings and described above. It is noteworthy that the specific embodiments may not only be implemented separately but also combined and implemented as needed selectively. The specific embodiments, which serve illustrative purposes only, are subject to various changes without departing from the scope and spirit of the disclosure and still fall within the scope of the claims of the disclosure. Therefore, the specific embodiments are not restrictive of the disclosure. The genuine scope and spirit of the disclosure shall be defined by the appended claims of the disclosure.

What is claimed is:

1. A medical image analysis system, comprising:
a database for storing a first medical image data indicating a target medical image; and
a server for accessing the database, the server comprising:
a first analysis module for generating a first determination data according to the first medical image data, the first determination data indicating whether the target medical image comprises a cancerous tissue image or indicating a chance of the target medical image comprising a cancerous tissue image;
a second analysis module for generating a second determination data according to the first medical image data, the second determination data indicating whether the target medical image comprises a cancerous tissue image or indicating a chance of the target medical image comprising a cancerous tissue image; and
an ensemble module communicatively connected with the first analysis module and the second analysis module and generating a third determination data according to the first determination data and the second determination data, the third determination data indicating whether the target medical image comprises a cancerous tissue image or indicating a chance of the target medical image comprising a cancerous tissue image;
wherein the server trains the first analysis module with a plurality of first image training data, a plurality of second image training data and a plurality of third image training data to allow the first analysis module to generate the first determination data according to the first medical image data,
wherein the server trains the second analysis module with the plurality of first image training data, the plurality of second image training data and the plurality of third image training data to allow the second analysis module to generate the second determination data according to the first medical image data,
wherein the plurality of first image training data each indicate a medical image containing normal tissue, the plurality of second image training data each indicate a medical image containing cancerous tissue, and the plurality of third image training data each indicate a medical image containing non-cancerous, abnormal tissue.

2. The medical image analysis system of claim 1, wherein the first analysis module comprises a deep learning model, and the second analysis module comprises a radiomic module and a machine learning model,
wherein the first analysis module generates the first determination data according to the first medical image data with the deep learning model,
wherein the second analysis module generates the second determination data according to the first medical image data with the radiomic module and the machine learning model.

3. The medical image analysis system of claim 2, wherein the server comprises a segmentation module communicatively connected with the first analysis module and the second analysis module,
wherein the segmentation module generates a target image data according to the first medical image data, with the target image data correlating with the first medical image data and indicating a target organ image in the target medical image,
wherein the first analysis module generates the first determination data according to the target image data correlating with the first medical image data,
wherein the second analysis module generates the second determination data according to the target image data correlating with the first medical image data.

4. The medical image analysis system of claim 3, wherein the radiomic module generates a feature data according to the target image data, and the machine learning model generates the second determination data according to the feature data.

5. The medical image analysis system of claim 1, wherein the third determination data comprises a first risk data indicating a chance of the target medical image comprising a cancerous tissue image.

6. The medical image analysis system of claim 1, wherein the database stores a plurality of second medical image data and a plurality of third medical image data, the plurality of second medical image data each indicate a specific non-cancerous tissue medical image, and the plurality of third medical image data each indicate a specific cancerous tissue medical image,
wherein the server generates a fourth determination data according to each of the plurality of second medical image data, the plurality of fourth determination data each comprising a second risk data,
wherein the server generates a fifth determination data according to each of the plurality of third medical image data, the plurality of fifth determination data each comprising a third risk data,
wherein the server generates a range data according to the plurality of second risk data and the plurality of third risk data, the range data indicating a plurality of ranges.

7. The medical image analysis system of claim 6, wherein the plurality of second risk data each indicate a first risk value, and the plurality of third risk data each indicate a second risk value,
wherein the server sorts the plurality of second risk data by the plurality of first risk values and generates a plurality of non-cancerous ranges according to the plurality of second risk data sorted,
wherein the server sorts the plurality of third risk data by the plurality of second risk values and generates a plurality of cancerous ranges according to the plurality of third risk data sorted,
wherein the server generates the range data according to the plurality of non-cancerous ranges and the plurality of cancerous ranges.

8. The medical image analysis system of claim 7, wherein the plurality of non-cancerous ranges comprise a first non-cancerous range,
wherein a plurality of fourth risk data in the plurality of second risk data fall within the first non-cancerous range,
wherein the server generates a first likelihood ratio data according to the plurality of fourth risk data, and the first likelihood ratio data indicates a first likelihood ratio value,
wherein the server causes the range data to indicate the first non-cancerous range and the first likelihood ratio data, and causes the first non-cancerous range in the range data to correlate with the first likelihood ratio data in the range data.

9. The medical image analysis system of claim 7, wherein the plurality of non-cancerous ranges comprise a first non-cancerous range and a second non-cancerous range preceding the first non-cancerous range,
wherein a plurality of fourth risk data in the plurality of second risk data fall within the first non-cancerous range, and a plurality of fifth risk data in the plurality of second risk data fall within the second non-cancerous range,
wherein the server generates a first likelihood ratio data according to the plurality of fourth risk data, and the first likelihood ratio data indicates a first likelihood ratio value,
wherein the server generates a second likelihood ratio data according to the plurality of fifth risk data, and the second likelihood ratio data indicates a second likelihood ratio value,
wherein the server combines the first non-cancerous range and the second non-cancerous range based on a first ratio between the first likelihood ratio value and the second likelihood ratio value is less than a first predetermined numerical value.

10. The medical image analysis system of claim 7, wherein the plurality of cancerous ranges comprise a first cancerous range,
wherein a plurality of sixth risk data in the plurality of third risk data fall within the first cancerous range,
wherein the server generates a third likelihood ratio data according to the plurality of sixth risk data, and the third likelihood ratio data indicates a third likelihood ratio value,
wherein the server causes the range data to indicate the first cancerous range and the third likelihood ratio data, and causes the first cancerous range in the range data to correlate with the third likelihood ratio data in the range data.

11. The medical image analysis system of claim 7, wherein the plurality of cancerous ranges comprise a first cancerous range and a second cancerous range preceding the first cancerous range,
wherein a plurality of sixth risk data in the plurality of third risk data fall within the first cancerous range, and a plurality of seventh risk data in the plurality of third risk data fall within the second cancerous range,
wherein the server generates a third likelihood ratio data according to the plurality of sixth risk data, and the third likelihood ratio data indicates a third likelihood ratio value,
wherein the server generates a fourth likelihood ratio data according to the plurality of seventh risk data, and the fourth likelihood ratio data indicates a fourth likelihood ratio value,
wherein the server combines the first cancerous range and the second cancerous range based on a second ratio between the third likelihood ratio value and the fourth likelihood ratio value is less than a second predetermined numerical value.

12. A medical image analysis method, applicable to a medical image analysis system comprising a database and a server, the server accessing the database and comprising a first analysis module, a second analysis module and an ensemble module, the database storing a first medical image data indicating a target medical image, the ensemble module communicatively connected with the first analysis module and the second analysis module, wherein the medical image analysis method comprises the steps of:
training, by the server, the first analysis module with a plurality of first image training data, a plurality of second image training data and a plurality of third image training data to allow the first analysis module to generate a first determination data according to the first medical image data;
training, by the server, the second analysis module with the plurality of first image training data, the plurality of second image training data and the plurality of third image training data to allow the second analysis module to generate a second determination data according to the first medical image data;
generating, by the first analysis module, the first determination data according to the first medical image data, the first determination data indicating whether the target medical image comprises a cancerous tissue image or indicating a chance of the target medical image comprising a cancerous tissue image;
generating, by the second analysis module, the second determination data according to the first medical image data, the second determination data indicating whether the target medical image comprises a cancerous tissue image or indicating a chance of the target medical image comprising a cancerous tissue image; and
generating, by the ensemble module, a third determination data according to the first determination data and the second determination data, the third determination data indicating whether the target medical image comprises a cancerous tissue image or indicating a chance of the target medical image comprising a cancerous tissue image,
wherein the plurality of first image training data each indicate a medical image containing normal tissue, the plurality of second image training data each indicate a medical image containing cancerous tissue, and the plurality of third image training data each indicate a medical image containing non-cancerous, abnormal tissue.

13. The medical image analysis method of claim 12, wherein the first analysis module comprises a deep learning model, and the second analysis module comprises a radiomic module and a machine learning model, wherein the medical image analysis method further comprises the steps of:
generating, by the first analysis module, the first determination data according to the first medical image data with the deep learning model; and
generating, by the second analysis module, the second determination data according to the first medical image data with the radiomic module and the machine learning model.

14. The medical image analysis method of claim 13, wherein the server comprises a segmentation module communicatively connected with the first analysis module and the second analysis module, wherein the medical image analysis method further comprises the steps of:
generating, by the segmentation module, a target image data according to the first medical image data, the target image data correlating with the first medical image data and indicating a target organ image in the target medical image;
generating, by the first analysis module, the first determination data according to the target image data correlating with the first medical image data; and
generating, by the second analysis module, the second determination data according to the target image data correlating with the first medical image data.

15. The medical image analysis method of claim 14, further comprising the steps of:
generating, by the radiomic module, a feature data according to the target image data; and
generating, by the machine learning model, the second determination data according to the feature data.

16. The medical image analysis method of claim 12, wherein the third determination data comprises a first risk data, and the first risk data indicates a chance of the target medical image comprising a cancerous tissue image.

17. The medical image analysis method of claim 12, wherein the database stores a plurality of second medical image data and a plurality of third medical image data, the plurality of second medical image data each indicate a specific non-cancerous tissue medical image, and the plurality of third medical image data each indicate a specific cancerous tissue medical image, wherein the medical image analysis method further comprises the steps of:
generating, by the server, a fourth determination data according to each of the plurality of second medical image data, the plurality of fourth determination data each comprising a second risk data;
generating, by the server, a fifth determination data according to each of the plurality of third medical image data, the plurality of fifth determination data each comprising a third risk data; and
generating, by the server, a range data according to the plurality of second risk data and the plurality of third risk data, the range data indicating a plurality of ranges.

18. The medical image analysis method of claim 17, wherein the plurality of second risk data each indicate a first risk value, and the plurality of third risk data each indicate a second risk value, wherein the medical image analysis method further comprises the steps of:
sorting, by the server, the plurality of second risk data by the plurality of first risk values;
generating, by the server, a plurality of non-cancerous ranges according to the plurality of second risk data sorted;
sorting, by the server, the plurality of third risk data by the plurality of second risk values;
generating, by the server, a plurality of cancerous ranges according to the plurality of third risk data sorted; and
generating, by the server, the range data according to the plurality of non-cancerous ranges and the plurality of cancerous ranges.

19. The medical image analysis method of claim 18, wherein the plurality of non-cancerous ranges comprise a first non-cancerous range, and a plurality of fourth risk data in the plurality of second risk data fall within the first non-cancerous range, wherein the medical image analysis method further comprises the steps of:
generating, by the server, a first likelihood ratio data according to the plurality of fourth risk data, the first likelihood ratio data indicating a first likelihood ratio value;
causing, by the server, the range data to indicate the first non-cancerous range and the first likelihood ratio data; and
causing, by the server, the first non-cancerous range in the range data to correlate with the first likelihood ratio data in the range data.

20. The medical image analysis method of claim 18, wherein the plurality of non-cancerous ranges comprise a first non-cancerous range and a second non-cancerous range preceding the first non-cancerous range, a plurality of fourth risk data in the plurality of second risk data fall within the first non-cancerous range, and a plurality of fifth risk data in the plurality of second risk data fall within the second non-cancerous range, wherein the medical image analysis method further comprises the steps of:
generating, by the server, a first likelihood ratio data according to the plurality of fourth risk data, the first likelihood ratio data indicating a first likelihood ratio value;
generating, by the server, a second likelihood ratio data according to the plurality of fifth risk data, the second likelihood ratio data indicating a second likelihood ratio value; and
combining, by the server, the first non-cancerous range and the second non-cancerous range based on a first ratio between the first likelihood ratio value and the second likelihood ratio value is less than a first predetermined numerical value.

21. The medical image analysis method of claim 18, wherein the plurality of cancerous ranges comprise a first cancerous range, and a plurality of sixth risk data in the plurality of third risk data fall within the first cancerous range, wherein the medical image analysis method further comprises the steps of:
generating, by the server, a third likelihood ratio data according to the plurality of sixth risk data, the third likelihood ratio data indicating a third likelihood ratio value;
causing, by the server, the range data to indicate the first cancerous range and the third likelihood ratio data; and
causing, by the server, the first cancerous range in the range data to correlate with the third likelihood ratio data in the range data.

22. The medical image analysis method of claim 18, wherein the plurality of cancerous ranges comprise a first cancerous range and a second cancerous range preceding the first cancerous range, a plurality of sixth risk data in the plurality of third risk data fall within the first cancerous range, and a plurality of seventh risk data in the plurality of third risk data fall within the second cancerous range, wherein the medical image analysis method further comprises the steps of:
generating, by the server, a third likelihood ratio data according to the plurality of sixth risk data, the third likelihood ratio data indicating a third likelihood ratio value;
generating, by the server, a fourth likelihood ratio data according to the plurality of seventh risk data, the fourth likelihood ratio data indicating a fourth likelihood ratio value; and
combining, by the server, the first cancerous range and the second cancerous range based on a second ratio between the third likelihood ratio value and the fourth likelihood ratio value is less than a second predetermined numerical value.
